(19) United States
(12) Patent Application Publication
(10) Pub. No.: US 2025/0035868 A1
(43) Pub. Date: Jan. 30, 2025

(54) OPTICAL MODULE

(71) Applicant: SUMITOMO ELECTRIC INDUSTRIES, LTD., Osaka-shi, Osaka (JP)

(72) Inventors: Taisuke NAGASAKI, Osaka-shi (JP); Takeshi INOUE, Osaka-shi (JP); Kensaku SHIMADA, Osaka-shi (JP); Toshihisa YOKOCHI, Osaka-shi (JP); Tatsuhiko NAITO, Osaka-shi (JP); Takashi YAMADA, Osaka-shi (JP)

(73) Assignee: SUMITOMO ELECTRIC INDUSTRIES, LTD., Osaka-shi, Osaka (JP)

(21) Appl. No.: 18/716,205

(22) PCT Filed: Dec. 5, 2022
(86) PCT No.: PCT/JP2022/044795

§ 371 Date: Jun. 4, 2024

(30) Foreign Application Priority Data
Jan. 11, 2022 (JP) 2022-002432

(51) Int. Cl. G02B 6/42

(52) U.S. Cl. CPC G02B 6/4269; G02B 6/424; G02B 6/4245; G02B 6/4257; G02B 6/4272; G02B 6/4273; G02B 6/428

(57) ABSTRACT

This optical module includes a cable including an optical fiber, and a connector module. The connector module includes: a circuit board having a first surface and a second surface; a metal housing in which the circuit board is disposed and which includes a plate-shaped portion facing the second surface; a resin housing in which the metal housing is disposed; and a heat transfer member which is disposed on the second surface. The plate-shaped portion of the metal housing includes a first region overlapping with the heat transfer member in plan view, and a second region located around the first region. The first region is closer to the second surface than the second region, and is in contact with the heat transfer member. A heat insulating region is disposed between the first region and the resin housing.

### TECHNICAL FIELD

The present disclosure relates to an optical module.

### BACKGROUND ART

Patent literature 1 discloses an optical module including a connector module. The connector module includes a housing defining a space and a circuit board received in the space of the housing, and a heat transfer member of a cable and the circuit board of the connector module are thermally connected to each other by a thermal conductor. The circuit board is mounted with a photoelectric conversion unit connected with an optical fiber. The housing includes a housing made of metal and a housing made of a resin inside which the housing made of metal is disposed.

### CITATION LIST

### Patent Literature

Patent literature 1: Japanese Unexamined Patent Application Publication No. 2013-83946

### SUMMARY OF INVENTION

### Problems to be Solved by the Invention

The housing (housing) made of resin is heated to a high temperature by heat generated by a control IC and the like. Thus, it is difficult for users to handle the connector module with bare hands. Thus, it is desired to quickly release the heat generated by the control IC and the like to the outside of the connector module and to transfer the heat to the resin housing while dispersing the heat so that the resin housing does not locally become high in temperature.

In order to miniaturize the connector module, it is desired to quickly release and disperse the heat while controlling an increase in size of the resin housing.

An object of the present disclosure is to provide an optical module including a connector module capable of quickly releasing heat generated inside the connector module and dispersing and transferring the heat to a resin housing while controlling an increase in size of the resin housing.

### Means for Solving the Problems

The present disclosure provides an optical module includes a cable including an optical fiber, and a connector module having a front end and a rear end, and including an electrical connector at the front end, the cable being connected to the rear end, the optical fiber being inserted from the rear end. The connector module includes a circuit board having a first surface and a second surface provided on a side opposite to the first surface, a metal housing inside which the circuit board is disposed and including a plate member facing the second surface, a resin housing inside which the metal housing is disposed, an optical semiconductor device optically coupled to the optical fiber and mounted at the circuit board, an integrated circuit device mounted at the first surface, electrically connected to the optical semiconductor device, and electrically connected to the connector, and a heat transfer member disposed on the second surface. The plate member of the metal housing includes a first region overlapping the heat transfer member in plan view and a second region positioned around the first region. The first region is closer than the second region to the second surface and contacts the heat transfer member. A thermally insulating region is provided between the first region and the resin housing.

### Advantageous Effects of the Invention

According to the present disclosure, it is possible to provide an optical module including a connector module capable of quickly releasing heat generated inside the connector module and dispersing and transferring the heat to a resin housing while controlling an increase in size of the resin housing.

### BRIEF DESCRIPTION OF THE DRAWINGS

FIG. 1 is a perspective view showing an optical module according to an embodiment.

FIG. 2 is an exploded perspective view of the optical module shown in FIG. 1.

FIG. 3 is a view showing an upper surface of a circuit board.

FIG. 4 is a top perspective view of inside of a connector module.

FIG. 5 is an enlarged view of a fiber-side lens module.

FIG. 6 is a perspective view showing a housing lower portion.

FIG. 7 is a cross-sectional view taken along line VII-VII of FIG. 6.

FIG. 8 is a bottom perspective view of inside of a connector module.

FIG. 9 is an enlarged view of a metal member.

FIG. 10 is a cross-sectional view taken along line X-X of FIG. 1.

FIG. 11 is a cross-sectional view taken along line XI-XI of FIG. 1.

FIG. 12 is a diagram showing a modification of a connector module.

### DETAILED DESCRIPTION

### Description of Embodiments of Present Disclosure

First, the contents of embodiments of the present disclosure will be listed and explained. An optical module according to an embodiment is an optical module that includes a cable including an optical fiber, and a connector module having a front end and a rear end, including an electrical connector at the front end, the cable being connected to the rear end, the optical fiber being inserted from the rear end. The connector module includes a circuit board having a first surface and a second surface provided on a side opposite to the first surface, a metal housing inside which the circuit board is disposed and including a plate member facing the second surface, a resin housing inside which the metal housing is disposed, an optical semiconductor device optically coupled to the optical fiber and mounted at the circuit board, an integrated circuit device mounted at the first surface, electrically connected to the optical semiconductor device, and electrically connected to the connector, and a heat transfer member disposed on the second surface. The plate member of the metal housing includes a first region overlapping the heat transfer member in plan view and a second region located around the first region. The first region is closer than the second region to the second surface and contacts the heat transfer member. A thermally insulating region is provided between the first region and the resin housing.

In the connector module included in the optical module, the integrated circuit device is mounted at the first surface of the circuit board. The heat transfer member is disposed on the second surface provided on the side opposite to the first surface. Thus, when the integrated circuit device generates heat, the heat is conducted to the heat transfer member through the circuit board. Since the heat transfer member contacts the first region of the metal housing, the heat conducted to the heat transfer member is conducted to the metal housing. Thus, in the optical module, the heat generated in the connector module can be quickly released. In the optical module, the first region of the metal housing is closer than the second region to the second surface. Thus, the thermally insulating region can be provided between the first region of the metal housing and the resin housing while controlling an increase in the size of the resin housing. The thermally insulating region is provided between the first region and the resin housing, and thus a local increase in the temperature of the resin housing is suppressed. As a result, in the optical module, it is possible to disperse and transfer the heat generated inside the connector module to the resin housing while controlling an increase in the size of the resin housing.

In an embodiment, the heat transfer member may extend toward the rear end from a portion where the heat transfer member overlaps the first region. In this case, the heat conducted to the heat transfer member through the circuit board is conducted toward the rear end through the heat transfer member. Thus, the heat can be quickly released from the side of the rear end of the connector module to the cable.

In an embodiment, the thermally insulating region may be a gap. In this case, the heat conducted to the first region of the metal housing is conducted to the second region before being conducted to the resin housing through the air included in the gap of the thermally insulating region. Thus, the heat generated inside the connector module can be dispersed without being locally conducted to the resin housing.

In an embodiment, the thermally insulating region may include a thermally insulating member. In this case, the heat conducted to the first region of the metal housing is conducted to the second region while avoiding the thermally insulating member. Thus, the heat generated inside the connector module can be dispersed without being locally conducted to the resin housing.

In an embodiment, the cable may further include a braided wire. In this case, the heat conducted to the side of the rear end of the connector module is quickly released to the braided wire.

In an embodiment, the connector module may further include a metal member provided at an end of the circuit board on a side of the rear end inside the metal housing. In the metal member, a portion situated on a side of the first surface and portion situated on a side of the second surface may be integrally formed. In this case, the heat conducted to the side of the rear end of the circuit board is further conducted to rearward through the metal member. Thus, the heat can be quickly released from the side of the rear end of the connector module to the cable.

In an embodiment, the connector module may further include a metal member provided at an end of the circuit board on a side of the rear end inside the metal housing, and whose portion situated on a side of the first surface and portion situated on a side of the second surface are integrally formed. The metal member may contact the braided wire. In this case, the heat conducted to the metal member is efficiently conducted to the braided wire. Thus, the heat generated inside the connector module can be quickly released to the braided wire.

In an embodiment, the metal member may be adhered to the circuit board with a thermally conductive adhesive. In this case, the metal member and the circuit board are securely fixed to each other by the adhesive. Further, since the adhesive is thermally conductive, the heat conducted through the circuit board is efficiently conducted to the metal member. Thus, the heat generated inside the connector module can be more quickly released.

In an embodiment, the heat transfer member may contact the metal member. In this case, the heat conducted to the side of the rear end of the heat transfer member through the heat transfer member is efficiently conducted to the metal member. Thus, the heat generated inside the connector module can be more quickly released.

In an embodiment, a surface of the heat transfer member may include a step whose shape follows a step between the first region and the second region. In this case, the heat conducted through the circuit board is conducted directly from the heat transfer member to the second region as well as the first region. Thus, the heat generated inside the connector module can be more quickly released.

### Details of Embodiments of Present Disclosure

Specific examples of embodiments of the present disclosure will be described below with reference to the drawings. The present invention is not limited to these examples, but is defined by the scope of the claims, and is intended to include all modifications within the meaning and scope equivalent to the scope of the claims. In the description of the drawings, the same elements are denoted by the same reference numerals, and redundant description thereof will be omitted.

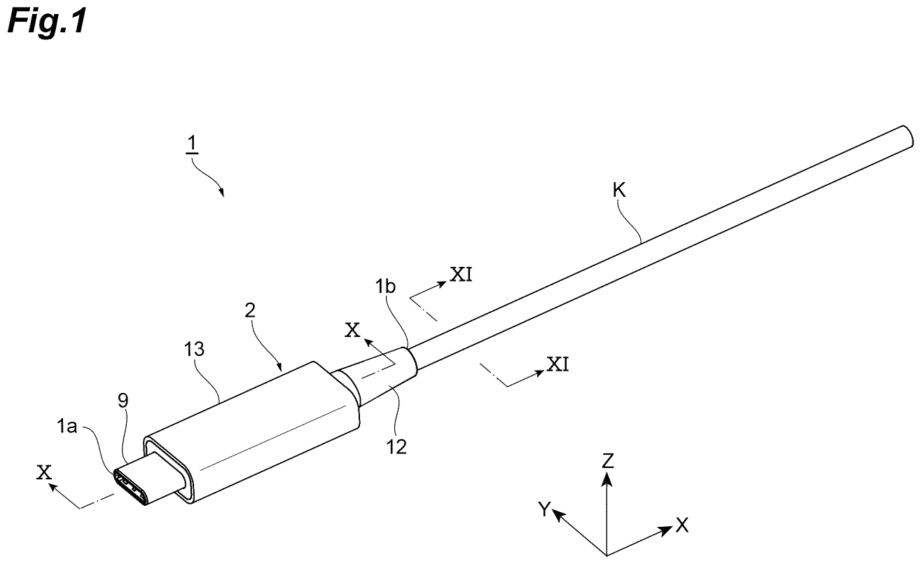

FIG. 1 is a perspective view showing an optical module 1 according to the embodiment. Optical module 1 includes a cable K including a plurality of optical fibers and a connector module 2 attached to a tip of cable K. Connector module 2 is a connector extending along a longitudinal direction X, and has a front end 1a and a rear end 1b in the longitudinal direction X. Rear end 1b is located on a side opposite to front end 1a in the longitudinal direction X. Connector module 2 includes an electrical connector at a side of front end 1a. Cable K is connected to a side of rear end 1b of connector module 2, and a plurality of optical fibers of cable K are inserted into connector module 2 from the side of rear end 1b. The plurality of optical fibers include first and second optical fibers.

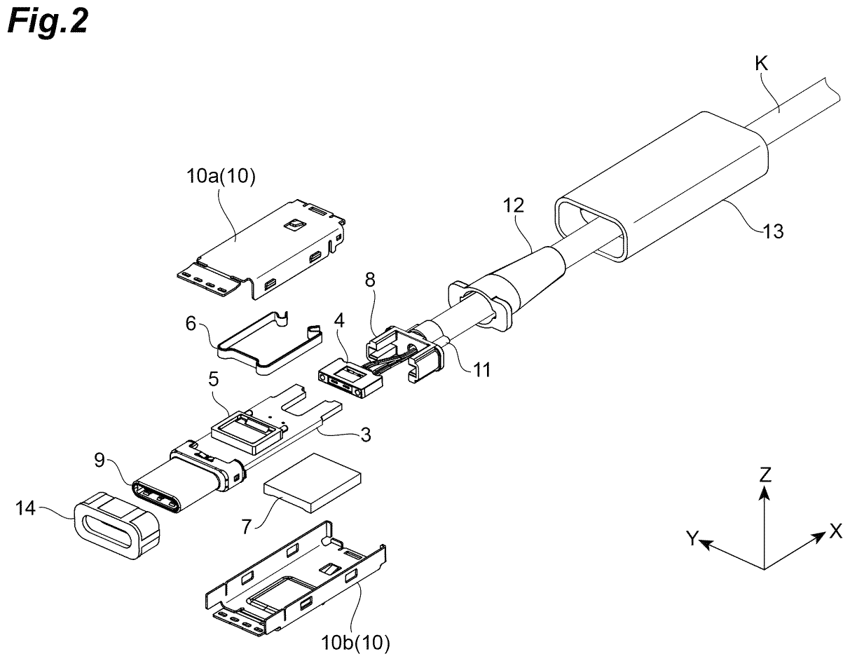

FIG. 2 is an exploded perspective view of optical module 1 shown in FIG. 1. As shown in FIGS. 1 and 2, connector module 2 includes a circuit board 3, a fiber-side lens module 4, a board-side lens module 5, a fitting spring 6, a heat transfer member 7, a metal member 8, a plug 9, a metal housing 10, a staking member 11, a strain relief 12, a resin housing 13, and a front cap 14.

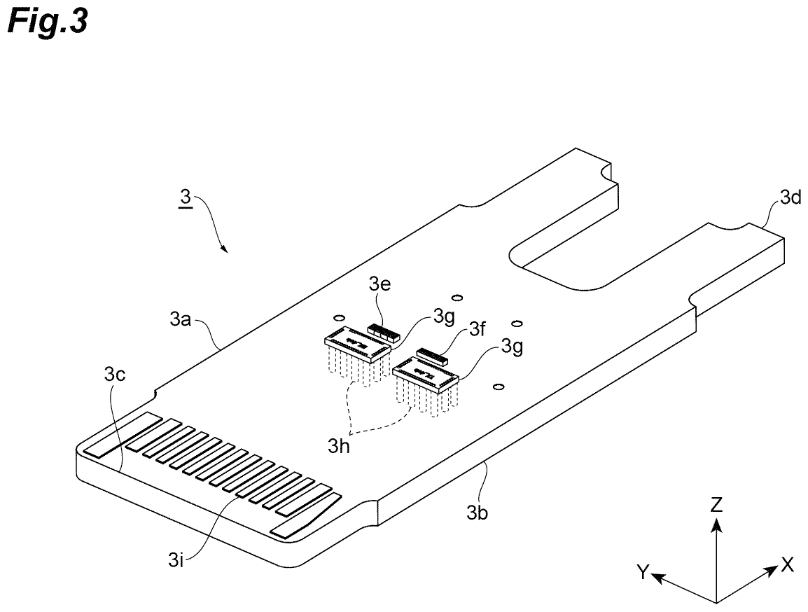

FIG. 3 is a view showing an upper surface of circuit board 3. Circuit board 3 includes an upper surface 3a (first surface), a lower surface 3b (second surface), a front end portion 3c, and a rear end portion 3d. Circuit board 3 is formed by forming a metal wiring pattern on a surface of a dielectric substrate having a substantially rectangular flat plate shape. Upper surface 3a and lower surface 3b are flat surfaces parallel to each other, have a Z direction as a normal direction, extend along an XY plane, and face opposite to each other. A plurality of electrical terminals 3i are arranged along front end portion 3c (along a Y direction) in portions of upper surface 3a and lower surface 3b closer to front end portion 3c. Rear end portion 3d has a U-shape with an open center in the Y direction of circuit board 3. A light-receiving device 3e as an optical semiconductor device, a light-emitting device 3f as another optical semiconductor device, and two integrated circuit devices 3g are mounted at upper surface 3a. Light-receiving device 3e is optically coupled to the first optical fiber inserted into connector module 2 and is electrically connected to one of integrated circuit devices 3g. Light-receiving device 3e converts light incident from the first optical fiber into an electric signal, and outputs the electric signal to the one of integrated circuit device 3g. Light-emitting device 3f is optically coupled to the second optical fiber inserted into connector module 2 and is electrically connected to the other integrated circuit device 3g. Light-emitting device 3f converts the electrical signal input from the other integrated circuit device 3g into light and emits the light to the second optical fiber. Integrated circuit devices 3g are large-scale integrated circuits that process electric signals at high speed. Circuit board 3 has two metal patterns (not shown) on upper surface 3a for mounting two integrated circuit devices 3g, respectively. A rear surface of each integrated circuit device 3g is fixed to the respective metal pattern by a conductive adhesive such as a conductive paste. In one example, these metal patterns are set to a reference potential (ground potential). Circuit board 3 further has two metal patterns (not shown) on lower surface 3b. The metal patterns of lower surface 3b overlap the metal patterns of upper surface 3a in plan view. Circuit board 3 includes a plurality of metal vias 3h that extend through a dielectric substrate in the Z direction and connect the metal pattern of upper surface 3a and the metal pattern of lower surface 3b.

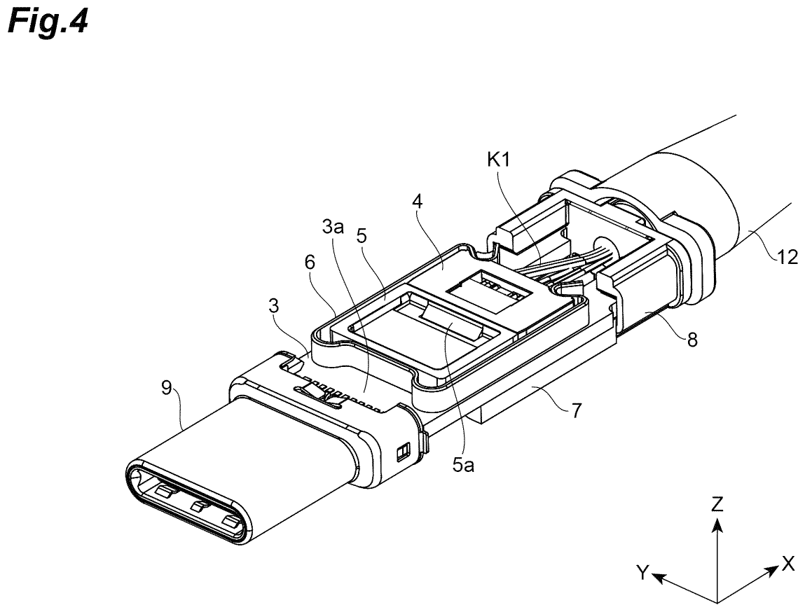

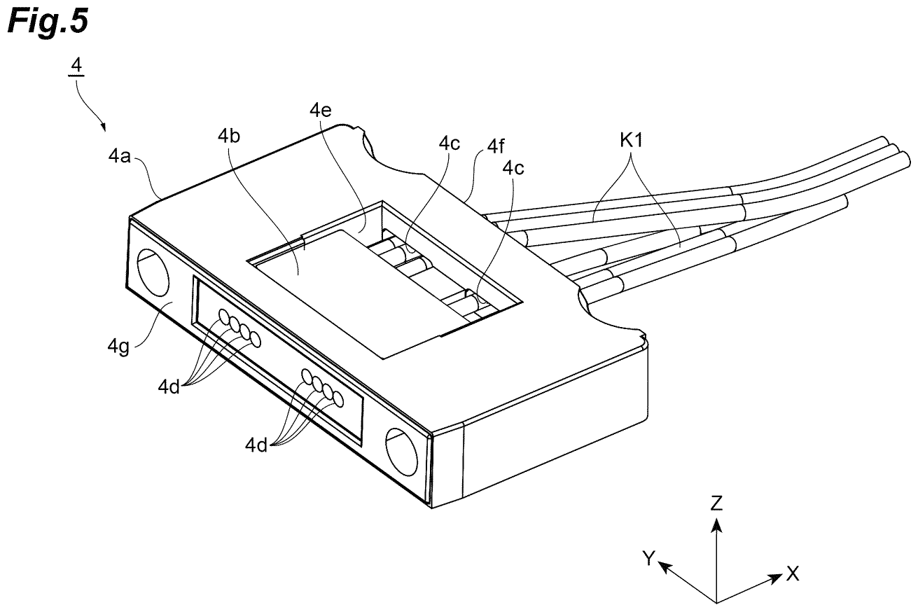

FIG. 4 is a top perspective view of the inside of connector module 2. Fiber-side lens module 4 and board-side lens module 5 are disposed on upper surface 3a of circuit board 3. Fiber-side lens module 4 and board-side lens module 5 are arranged side by side in an X direction on upper surface 3a of circuit board 3 such that board-side lens module 5 is positioned between fiber-side lens module 4 and front end portion 3c. Fiber-side lens module 4 and board-side lens module 5 optically couple the plurality of optical fibers K1 of cable K to light-receiving device 3e and light-emitting device 3f. That is, fiber-side lens module 4 and board-side lens module 5 cause light emitted from the first optical fibers among the plurality of optical fibers K1 to reach light-receiving device 3e, and cause light emitted from light-emitting device 3f to reach the second optical fibers among the plurality of optical fibers K1. The plurality of optical fibers K1 included in cable K are removed of coating resin in optical module 1, and are housed and held in fiber-side lens module 4. FIG. 5 is an enlarged perspective view of fiber-side lens module 4. Fiber-side lens module 4 includes a frame body 4a and a holding portion 4b. Frame body 4a and holding portion 4b are made of, for example, resin. Frame body 4a has a substantially rectangular parallelepiped shape, and a recessed portion 4e having a substantially rectangular parallelepiped shape is provided at the center of frame body 4a. Opening portions 4c into which optical fibers K1 are inserted are provided in an end surface 4f on a side of rear end 1b of frame body 4a in the X direction. Holding portion 4b has a rectangular shape when viewed in the Z direction. Holding portion 4b is disposed inside recessed portion 4e provided in frame body 4a. The plurality of optical fibers K1 inserted from end surface 4f of frame body 4a are divided into left and right at the rear of holding portion 4b, and are inserted into and held by a plurality of holes formed in holding portion 4b, respectively. On an end surface 4g on a side of front end 1a of frame body 4a in the X direction, a plurality of lenses 4d through which optical signals emitted from the first optical fibers among the plurality of held optical fibers K1 and optical signals incident on the second optical fibers among the plurality of held optical fibers K1 pass are provided side by side along the Y direction.

Referring again to FIG. 4. Board-side lens module 5 is made of, for example, resin and has a substantially rectangular parallelepiped shape. Board-side lens module 5 includes a reflecting mirror 5a that forms an angle of approximately 45° with respect to the X axis and the Z axis. Reflecting mirror 5a reflects light emitted from the first optical fibers among the plurality of optical fibers K1 inserted in fiber-side lens module 4 toward light-receiving device 3e, and reflects light emitted from light-emitting device 3f toward the second optical fibers among the plurality of optical fibers K1. Fitting spring 6 has a substantially U-shaped with a side of rear end 1b in the X direction being open. Fitting spring 6 is disposed around fiber-side lens module 4 and board-side lens module 5. Fitting spring 6 locks end surface 4f of fiber-side lens module 4 and elastically presses an end surface of board-side lens module 5 on a side of front end 1a, thereby fixing fiber-side lens module 4 and board-side lens module 5 to each other.

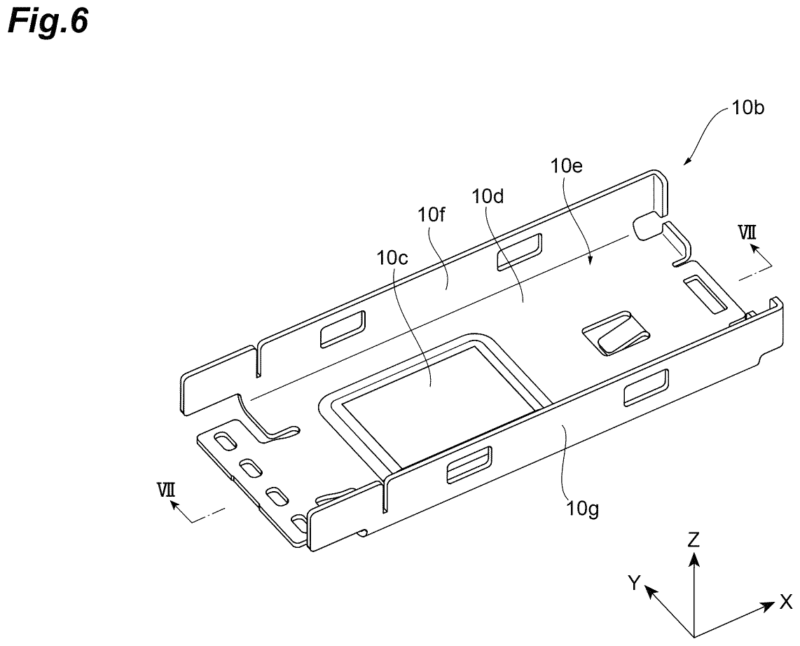

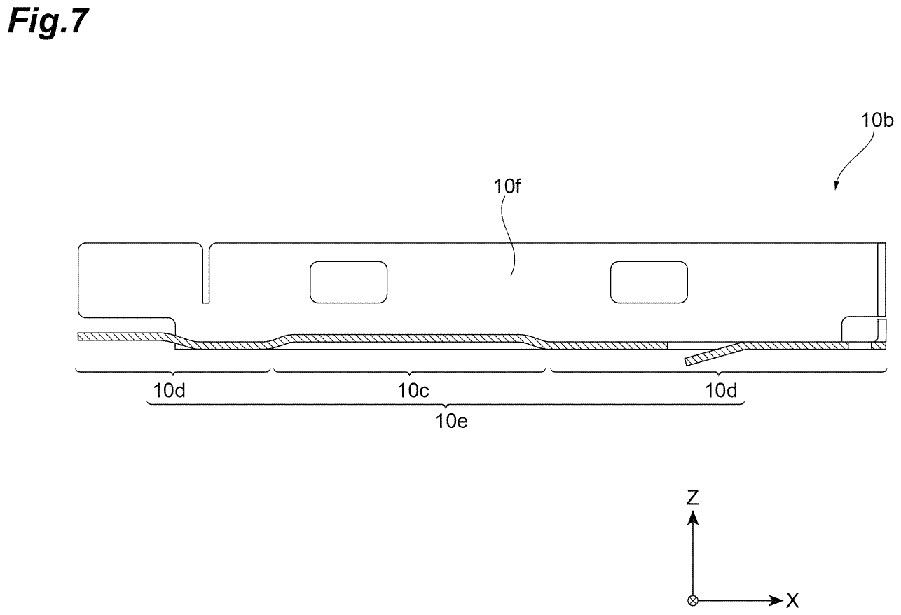

Metal housing 10 shown in FIG. 2 is made of metal such as copper alloy. Metal housing 10 includes a housing upper portion 10a and a housing lower portion 10b. Housing upper portion 10a and housing lower portion 10b are formed by bending a metal plate. Housing upper portion 10a includes an upper plate extending along the XY plane and a pair of side plates provided upright on both sides of the upper plate in the Y direction. Housing lower portion 10b includes a lower plate extending along the XY plane and a pair of side plates provided upright on both sides of the lower plate in the Y direction. The pair of side plates of housing upper portion 10a and the pair of side plates of housing lower portion 10b are fitted to each other, so that housing upper portion 10a and housing lower portion 10b are connected to each other. Circuit board 3 is disposed inside metal housing 10 formed by housing upper portion 10a and housing lower portion 10b. FIG. 6 is a perspective view showing housing lower portion 10b. FIG. 7 is a cross-sectional view taken along line VII-VII of FIG. 6. As described above, housing lower portion 10b includes a lower plate 10e and a pair of side plates 10f and 10g. Lower plate 10e faces circuit board 3 in the Z direction. Lower plate 10e of housing lower portion 10b includes a region 10c (first region) and a region 10d (second region). Region 10c extends along the XY plane and is provided at a position overlapping heat transfer member 7 and two integrated circuit devices 3g when viewed from the Z direction, that is, in plan view. Region 10d is a portion of lower plate 10e excluding region 10c, extends along the XY plane, and is provided around region 10d. Region 10c is closer than region 10d to circuit board 3. In other words, a distance between region 10c and circuit board 3 is shorter than a distance between region 10d and circuit board 3. Thus, region 10c is raised with respect to region 10d on the surface of lower plate 10e facing circuit board 3. In addition, region 10c is recessed with respect to region 10d on the surface of lower plate 10e opposite to the surface facing circuit board 3. A step is formed at a boundary portion between region 10c and region 10d. Such a shape of housing lower portion 10b may be formed by, for example, sheet metal processing.

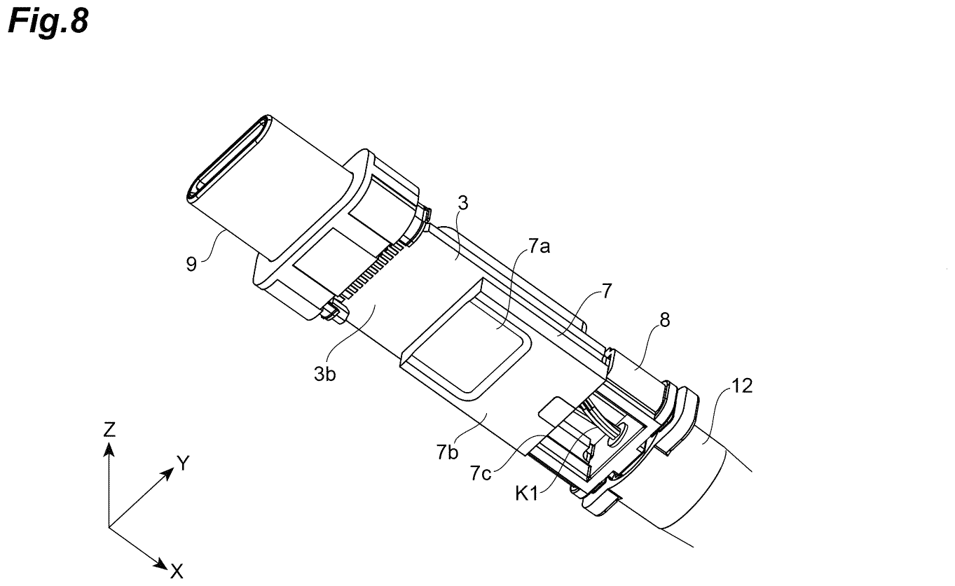

FIG. 8 is a bottom perspective view of the inside of connector module 2. Heat transfer member 7 is disposed on lower surface 3b of circuit board 3. Heat transfer member 7 is positioned between lower surface 3b of circuit board 3 and housing lower portion 10b. Heat transfer member 7 is in contact with lower surface 3b of circuit board 3 or in contact with the metal patterns provided on lower surface 3b. Heat transfer member 7 is disposed at a position overlapping two integrated circuit devices 3g when viewed in the normal direction of upper surface 3a and lower surface 3b of circuit board 3. In one example, an outline of heat transfer member 7 includes outlines of two integrated circuit devices 3g when viewed in the normal direction of upper surface 3a and lower surface 3b. Heat transfer member 7 transfers heat that is conducted from integrated circuit devices 3g, which is a heating element, through circuit board 3 (particularly, metal vias 3h that extend through the dielectric substrate) to housing lower portion 10b. A surface of heat transfer member 7 includes a step whose shape follows the step of housing lower portion 10b. Specifically, heat transfer member 7 has a surface 7a and a surface 7b on a surface opposite to a surface facing circuit board 3 in the Z direction. Surface 7a faces region 10c of housing lower portion 10b and has a rectangular flat surface shape. Surface 7b faces region 10d of housing lower portion 10b and surrounds three sides of surface 7a except for one side on a side of front end 1a among the four sides of surface 7a. Surface 7a is located closer than surface 7b to circuit board 3. Thus, heat transfer member 7 has a substantially rectangular parallelepiped shape with a part thereof being recessed. A distance between surface 7a and surface 7b of heat transfer member 7 in the Z direction is equal to a distance between region 10c and region 10d of housing lower portion 10b in the Z direction. Surface 7a of heat transfer member 7 and region 10c of housing lower portion 10b contact with each other, and surface 7b of heat transfer member 7 and region 10d of housing lower portion 10b contact with each other. Heat transfer member 7 mainly includes a material having high thermal conductivity. Heat transfer member 7 mainly includes, for example, an acrylic resin material. Heat transfer member 7 extends from a portion of housing lower portion 10b overlapping region 10c toward rear end 1b in the X direction. Heat transfer member 7 has a rear end surface 7c. Rear end surface 7c contacts metal member 8 described later.

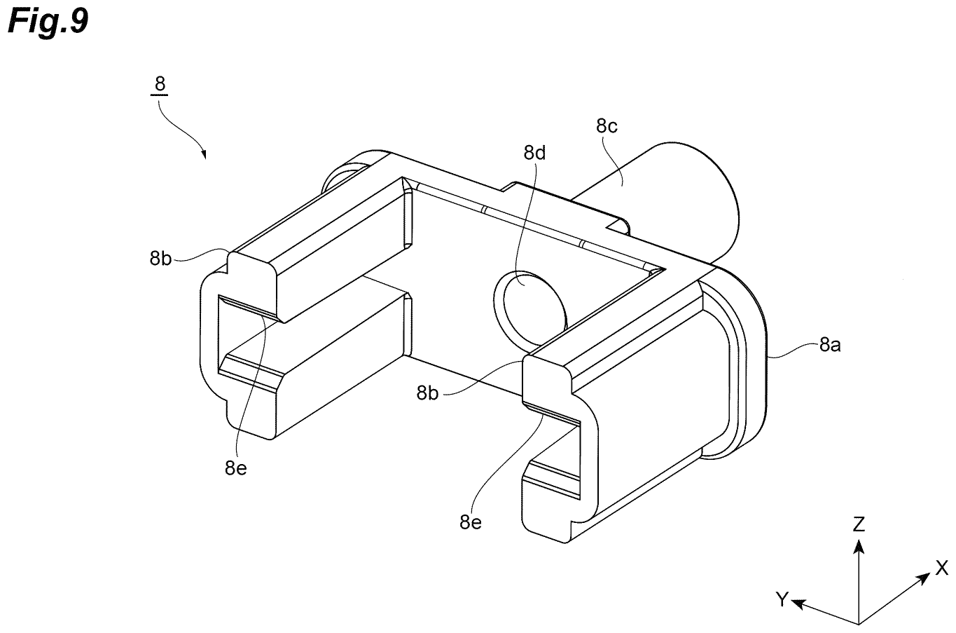

FIG. 9 is an enlarged view of metal member 8. Metal member 8 is connected to a plurality of cables K and holds circuit board 3. Metal member 8 may be formed by casting, for example. Metal member 8 includes a base 8a, a pair of support portions 8b, and a cylindrical portion 8c. Base 8a has a substantially rectangular flat plate shape, extends along an YZ plane, and has a through hole 8d at the center. Cylindrical portion 8c communicates with through hole 8d. Each support portion 8b has a slit 8e. Rear end portion 3d of circuit board 3 is inserted into slits 8e, and rear end portion 3d is held by metal member 8. That is, support portion 8b is formed by integrally forming a portion situated on a side of upper surface 3a of circuit board 3 and a portion situated on a side of lower surface 3b of circuit board 3. Metal member 8 and circuit board 3 are adhered to each other with a thermally conductive adhesive. The thermal conductivity of the thermally conductive adhesive is, for example, 3 W/mK. The plurality of optical fibers K1 are inserted into cylindrical portion 8c and protrude forward from through hole 8d. A space having a rectangular shape in plan view is provided by base 8a of metal member 8, the pair of support portions 8b, and rear end portion 3d of circuit board 3. This space suppresses the plurality of optical fibers K1 from contacting circuit board 3 and metal member 8, and thus decreases damage to the plurality of optical fibers K1.

Plug 9 covers and protects a plurality of terminals 3i provided in front end portion 3c of circuit board 3, and is connected to a connector provided in another circuit board (not shown). Front end portion 3c of circuit board 3 is inserted into an insertion opening of plug 9 on a side of rear end 1b in the X direction, whereby plug 9 is attached to circuit board 3.

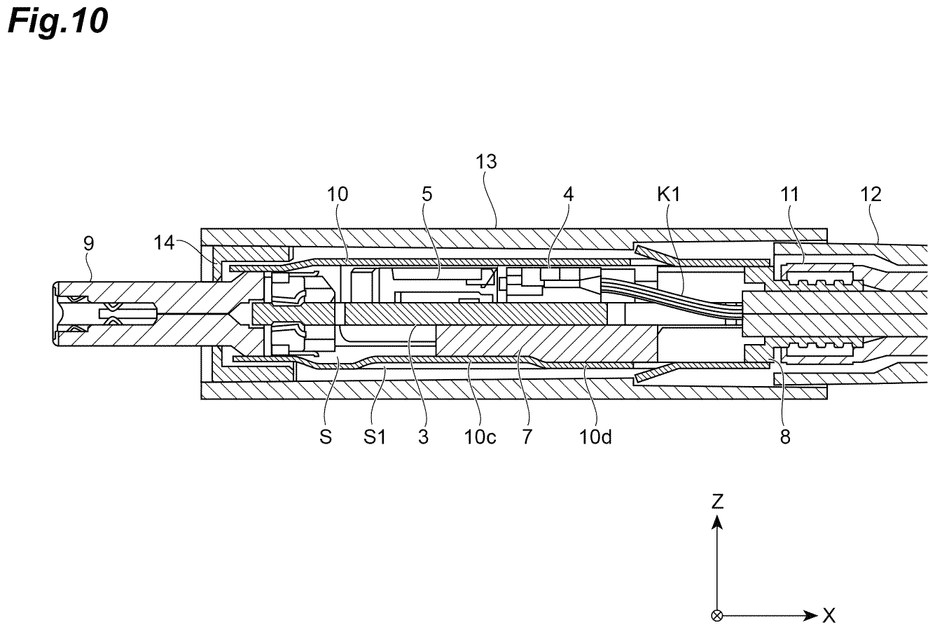

FIG. 10 is a cross-sectional view taken along line X-X of FIG. 1. Metal housing 10 conducts heat generated inside connector module 2 to resin housing 13. Metal housing 10 has a substantially rectangular tubular shape and extends along the X direction. Both ends of metal housing 10 in the X direction are closed by plug 9 and metal member 8, and an internal space S of metal housing 10 is defined. In internal space S, circuit board 3, fiber-side lens module 4, board-side lens module 5, fitting spring 6, and heat transfer member 7 are disposed.

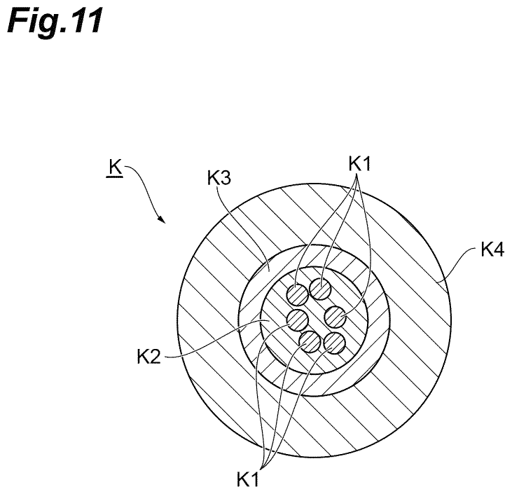

FIG. 11 is a cross-sectional view taken along line XI-XI of FIG. 1. Cable K includes the plurality of optical fibers K1, an inclusion K2, a braided wire K3, and a tube K4. The plurality of optical fibers K1 are disposed at the center of cable K. Inclusion K2 covers the plurality of optical fibers K1. Braided wire K3 is disposed around inclusion K2 and is made of metal. Tube K4 is disposed around braided wire K3. As an example, inclusion K2 mainly includes aramid fibers, and tube K4 mainly includes polyvinyl chloride. When cable K is connected to metal member 8, the plurality of optical fibers K1 and inclusion K2 are inserted into inside of cylindrical portion 8c, and braided wire K3 and tube K4 are disposed around cylindrical portion 8c. At this time, braided wire K3 contacts cylindrical portion 8c.

Staking member 11 shown in FIGS. 2 and 10 connects and fixes cable K and metal member 8 to each other. Staking member 11 has a cylindrical shape. The inner diameter of staking member 11 is slightly larger than cylindrical portion 8c around which braided wire K3 and tube K4 are disposed. Cable K and metal member 8 can be fixed to each other by disposing staking member 11 around tube K4 and staking cylindrical portion 8c, braided wire K3, and tube K4 together. Further, braided wire K3 can have a sufficient contact area with respect to metal member 8 by being staked with staking member 11.

Strain relief 12 shown in FIGS. 1 and 2 relieves stress generated at a connection portion between cable K and metal member 8. Strain relief 12 has a circular cross-section perpendicular to the X direction, and its diameter increases from rear end 1b toward front end 1a. Strain relief 12 has a rectangular flat plate at a front end. Cylindrical portion 8c of metal member 8, cable K, and staking member 11 are disposed inside strain relief 12. Strain relief 12 is made of, for example, resin.

Resin housing 13 shown in FIGS. 1, 2, and 10 is a housing made of resin, and releases heat conducted from metal housing 10 to the outside of connector module 2. Metal housing 10 is disposed inside resin housing 13. Resin housing 13 has a rectangular tubular shape extending in the X direction. That is, resin housing 13 has an opening portion on a front side and an opening portion on a rear side. Plug 9 protrudes forward from the opening portion on the front side. Strain relief 12 protrudes rearward from the opening portion on the rear side.

In a state where metal housing 10 is disposed inside resin housing 13, region 10d of metal housing 10 contacts resin housing 13, but region 10c does not contact resin housing 13. That is, as shown in FIG. 10, a thermally insulating region S1 is provided between region 10c and resin housing 13. In the embodiment, thermally insulating region S1 is a gap.

Front cap 14 is fitted into the opening portion on the front side of resin housing 13 to close the opening portion. Front cap 14 has a through hole corresponding to plug 9. Thus, front cap 14 can be fitted into the opening portion on the front side of resin housing 13 by inserting plug 9 into the through hole of front cap 14.

Next, a flow of heat when integrated circuit devices 3g generate heat will be described. The heat generated by integrated circuit devices 3g is conducted to heat transfer member 7 through the dielectric substrate of circuit board 3 and the plurality of metal vias 3h inserted into the inside of the dielectric substrate. A part of the heat conducted to heat transfer member 7 is conducted to region 10c of metal housing 10. The heat conducted to region 10c is conducted to region 10d before being conducted to resin housing 13 through thermally insulating region S1. The heat conducted to region 10d is conducted from region 10d to resin housing 13. Thus, the heat generated in integrated circuit devices 3g is quickly released to resin housing 13. In this way, the heat generated in integrated circuit devices 3g is conducted to the periphery of thermally insulating region S1, avoiding thermally insulating region S1, and thus, it is possible to avoid a local rise in the temperature of resin housing 13.

A part of the heat conducted to heat transfer member 7 is conducted toward rear end surface 7c of heat transfer member 7. A part of the heat conducted toward rear end surface 7c is conducted to resin housing 13 through region 10d in contact with surface 7b. Another part of the heat conducted toward rear end surface 7c is conducted to metal member 8 in contact with heat transfer member 7. The heat conducted to metal member 8 is conducted to braided wire K3 and then to cable K. As described above, the heat generated in integrated circuit device 3g is conducted to resin housing 13 and cable K, and thus is rapidly released.

A part of the heat generated in integrated circuit devices 3g is conducted toward rear end portion 3d through circuit board 3. The heat conducted to rear end portion 3d is conducted to metal member 8 through the thermally conductive adhesive. The heat conducted to metal member 8 is conducted to braided wire K3 and then to cable K. In this way, the heat generated in integrated circuit devices 3g is conducted to cable K, and thus is quickly released.

In connector module 2 included in optical module 1 according to the embodiment described above, heat transfer member 7 is disposed on lower surface 3b of circuit board 3 at which integrated circuit devices 3g are mounted. Thus, when integrated circuit devices 3g generate heat, the heat is conducted to heat transfer member 7 through circuit board 3. Since heat transfer member 7 contacts region 10c of metal housing 10, the heat conducted to heat transfer member 7 is conducted to metal housing 10. Thus, in optical module 1, the heat generated inside connector module 2 can be quickly released. In connector module 2, region 10c of metal housing 10 is closer than region 10d to lower surface 3b. Thus, thermally insulating region S1 can be provided between region 10c and resin housing 13 while controlling an increase in the size of resin housing 13. Thermally insulating region S1 is provided between region 10c and resin housing 13, and thus a local increase in the temperature of resin housing 13 is prevented. As a result, in optical module 1, the heat generated inside connector module 2 can be dispersed and transferred to resin housing 13 while controlling an increase in the size of resin housing 13.

As in the embodiment, heat transfer member 7 may extend toward rear end 1b from a portion where heat transfer member 7 overlaps region 10c. Thus, the heat conducted to heat transfer member 7 through circuit board 3 is conducted to rear end surface 7c through heat transfer member 7. Thus, the heat can be quickly released from the side of rear end 1b of connector module 2 to cable K.

As in the embodiment, thermally insulating region S1 may be a gap. Accordingly, the heat conducted to region 10c of metal housing 10 is conducted to region 10d before being conducted to resin housing 13 through the air included in the gap of thermally insulating region S1. Thus, the heat generated inside connector module 2 can be dispersed without being locally conducted to resin housing 13.

As in the embodiment, connector module 2 may include metal member 8 provided at rear end portion 3d in internal space S of metal housing 10. In metal member 8, a portion situated on a side of upper surface 3a and a portion situated on a side of lower surface 3b may be integrally formed. Accordingly, the heat conducted to rear end portion 3d through circuit board 3 and heat transfer member 7 is further conducted to the rear side through metal member 8. Thus, the heat can be quickly released from the side of rear end 1b of connector module 2 to cable K.

As in the embodiment, metal member 8 may contact braided wire K3. Thus, the heat conducted to metal member 8 is efficiently conducted to braided wire K3. Thus, the heat generated inside connector module 2 can be quickly released to braided wire K3.

As in the embodiment, metal member 8 may be adhered to circuit board 3 with a thermally conductive adhesive. Thus, metal member 8 and circuit board 3 are securely fixed to each other with the adhesive. Further, since the adhesive is thermally conductive, the heat conducted through circuit board 3 is efficiently conducted to metal member 8. Thus, the heat generated inside connector module 2 can be more quickly released.

As in the embodiment, heat transfer member 7 may contact metal member 8. Accordingly, the heat conducted to a side of rear end 1b of heat transfer member 7 through heat transfer member 7 is conducted to metal member 8. Thus, the heat generated inside connector module 2 can be more quickly released.

As in the embodiment, a surface of heat transfer member 7 may include a step whose shape follows a step between region 10c and region 10d. Accordingly, the heat conducted to heat transfer member 7 through circuit board 3 is directly conducted from heat transfer member 7 to region 10d as well as region 10c. Thus, the heat generated inside connector module 2 can be more quickly released.

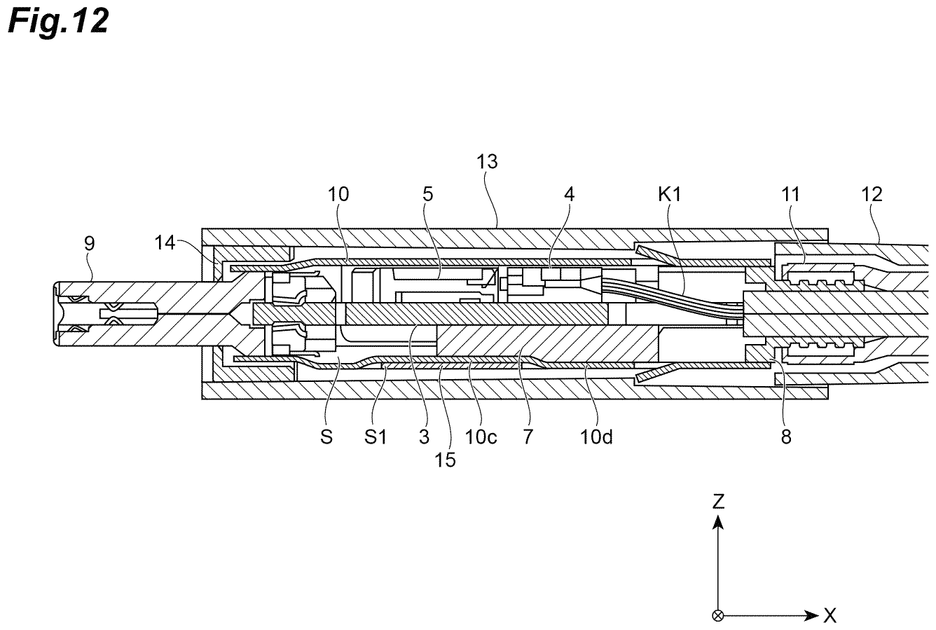

Although the embodiments of the present disclosure have been described in detail, the present disclosure is not limited to the above-described embodiments, and can be applied to various embodiments. For example, in the above embodiments, thermally insulating region S1 is a gap, but as shown in FIG. 12, a thermally insulating member 15 may be included instead of a gap or together with a gap. In this case, the heat conducted to region 10c of metal housing 10 is conducted to region 10d while avoiding the thermally insulating member 15. Thus, the heat generated inside connector module 2 can be dispersed without being locally conducted to resin housing 13.

Further, cable K of the above embodiments includes only optical fiber K1 inside inclusion K2, but may further include an electric wire in addition to optical fiber K1 inside inclusion K2.

### REFERENCE SIGNS LIST

1 optical module
1a front end
1b rear end
2 connector module
3 circuit board
3a upper surface (first surface)
3b lower surface (second surface)
3c front end portion
3d rear end portion
3e light-receiving device
3f light-emitting device
3g integrated circuit device
3h metal via
3i terminal
4 fiber-side lens module
4a frame body
4b holding portion
4c opening portion
4d lens
4e recessed portion
4f, 4g end surface
5 board-side lens module
5a reflecting mirror
6 fitting spring
7 heat transfer member
7a, 7b surface
7c rear end surface
8 metal member
8a base
8b support portion
8c cylindrical portion
8d through hole
8e slit
9 plug
10 metal housing
10a housing upper portion
10b housing lower portion
10c region (first region)
10d region (second region)
10e lower plate
10f, 10g side plate
11 staking member
12 strain relief
13 resin housing
K cable
K1 optical fiber
K2 inclusion
K3 braided wire
K4 tube
S internal space
S1 thermally insulating region

1. An optical module comprising:
a cable including an optical fiber; and
a connector module having a front end and a rear end, including an electrical connector at the front end, the cable being connected to the rear end, the optical fiber being inserted from the rear end,
wherein the connector module includes
a circuit board having a first surface and a second surface provided on a side opposite to the first surface,
a metal housing inside which the circuit board is disposed and including a plate member facing the second surface,
a resin housing inside which the metal housing is disposed,
an optical semiconductor device optically coupled to the optical fiber and mounted at the circuit board,
an integrated circuit device mounted at the first surface, electrically connected to the optical semiconductor device, and electrically connected to the connector, and
a heat transfer member disposed on the second surface,
wherein the plate member of the metal housing includes a first region overlapping the heat transfer member in plan view and a second region positioned around the first region,
wherein the first region is closer than the second region to the second surface and contacts the heat transfer member, and
wherein a thermally insulating region is provided between the first region and the resin housing.

2. The optical module according to claim 1,
wherein the heat transfer member extends toward the rear end from a portion where the heat transfer member overlaps the first region.

3. The optical module according to claim 1,
wherein the thermally insulating region is a gap.

4. The optical module according to claim 1,
wherein the thermally insulating region includes a thermally insulating member.

5. The optical module according to claim 1,
wherein the cable further includes a braided wire.

6. The optical module according to claim 1,
wherein the connector module further includes a metal member provided at an end of the circuit board on a side of the rear end inside the metal housing, and whose portion situated on a side of the first surface and portion situated on a side of the second surface are integrally formed.

7. The optical module according to claim 5,
wherein the connector module further includes a metal member provided at an end of the circuit board on a side of the rear end inside the metal housing, and whose portion situated on a side of the first surface and portion situated on a side of the second surface are integrally formed, and
wherein the metal member contacts the braided wire.

8. The optical module according to claim 6,
wherein the metal member is adhered to the circuit board with a thermally conductive adhesive.

9. The optical module according to claim 6,
wherein the heat transfer member contacts the metal member.

10. The optical module according to claim 1,
wherein a surface of the heat transfer member includes a step whose shape follows a step between the first region and the second region.

11. The optical module according to claim 7,
wherein the metal member is adhered to the circuit board with a thermally conductive adhesive.

12. The optical module according to claim 7,
wherein the heat transfer member contacts the metal member.
